(19) United States
(12) Patent Application Publication
(10) Pub. No.: US 2013/0013566 A1
(43) Pub. Date: Jan. 10, 2013

(54) STORAGE GROUP SYNCHRONIZATION IN DATA REPLICATION ENVIRONMENTS

(75) Inventors: Dash D. Miller, Tucson, AZ (US); David C. Reed, Tucson, AZ (US); Max D. Smith, Tucson, AZ (US); Herbert Yee, Vail, AZ (US)

(73) Assignee: INTERNATIONAL BUSINESS MACHINES CORPORATION, Armonk, NY (US)

(21) Appl. No.: 13/178,553

(22) Filed: Jul. 8, 2011

(51) Int. Cl. G06F 17/00

(52) U.S. Cl. 707/655; 707/E17.007

(57) ABSTRACT

A method for dynamically synchronizing storage groups in a data replication environment is disclosed. In one embodiment, such a method includes detecting the addition of a volume to a storage group of a primary storage system. The method then automatically performs the following in response to detecting the addition of the volume: (1) adds a corresponding volume to a corresponding storage group on a secondary storage system; (2) creates a mirroring relationship between the volume added to the primary storage system and the volume added to the secondary storage system; and (3) adds the mirroring relationship to a mirroring session established between the storage groups on the primary and secondary storage systems. A corresponding system and computer program product are also disclosed.

### BACKGROUND

1. Field of the Invention

This invention relates to systems and methods for synchronizing storage groups in data replication environments.

2. Background of the Invention

In data replication environments such as Peer-to-Peer Remote Copy (“PPRC”) or Extended Remote Copy (“XRC”) environments, data is mirrored from a primary storage system to a secondary storage system to maintain two consistent copies of the data. The primary and secondary storage systems may be located at different sites, perhaps hundreds or even thousands of miles away from one another. In the event the primary storage system fails, I/O may be redirected to the secondary storage system, thereby enabling continuous operations. When the primary storage system is repaired, I/O may resume to the primary storage system. The process of redirecting I/O from the primary storage system to the secondary storage system when a failure or other event occurs may be referred to as a “failover.”

Currently, users may establish storage groups (pools of volumes) on primary storage systems to accommodate applications that use a certain type of data. Each volume in a storage group may be assigned to a common “session,” or a linked group of “sessions,” so that each volume in the storage group has a consistent point of recovery. When a storage group is established on the primary storage system, a corresponding storage group may be established on the secondary storage system for mirroring purposes. Unfortunately, when users set up the mirrored relationship between storage groups, the user needs to ensure that any time changes are made to a storage group at the primary storage system, the same or similar changes are made to the corresponding storage group on the secondary storage system. This can be extremely difficult and time-consuming in environments where volumes are dynamically added to or removed from storage groups on the primary storage system (for end-of-month processing, for example) due to on-demand storage requirements.

In view of the foregoing, what are needed are systems and methods to more effectively synchronize storage groups in data replication environments. Ideally, such systems and methods will operate in an automated fashion in a way that is transparent to users.

### SUMMARY

The invention has been developed in response to the present state of the art and, in particular, in response to the problems and needs in the art that have not yet been fully solved by currently available systems and methods. Accordingly, the invention has been developed to more effectively synchronize storage groups in data replication environments. The features and advantages of the invention will become more fully apparent from the following description and appended claims, or may be learned by practice of the invention as set forth hereinafter.

Consistent with the foregoing, a method for dynamically synchronizing storage groups in a data replication environment is disclosed herein. In one embodiment, such a method includes detecting the addition of a volume to a storage group of a primary storage system. The method then automatically performs the following in response to detecting the addition of the volume: (1) adds a corresponding volume to a corresponding storage group on a secondary storage system; (2) creates a mirroring relationship between the volume added to the primary storage system and the volume added to the secondary storage system; and (3) adds the mirroring relationship to a mirroring session established between the storage groups on the primary and secondary storage systems. This will ensure that corresponding storage groups on the primary and secondary storage systems are synchronized with one another as much as possible.

A corresponding system and computer program product are also disclosed and claimed herein.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIG. 1 is a high-level block diagram showing one example of a data replication environment comprising a primary and secondary storage system;

FIG. 2 is a high-level block diagram showing one example of a system for automatically synchronizing storage groups in a data replication environment;

FIG. 3 is a high-level block diagram showing one embodiment of a mirroring management module used to synchronize storage groups;

FIG. 4 is a flow diagram showing one embodiment of a method for synchronizing storage groups when a volume is added to a storage group on a primary storage system;

FIG. 5 is a flow diagram showing one embodiment of a method for synchronizing storage groups when a volume is removed from a storage group on a primary storage system; and

FIG. 6 is a high-level block diagram showing another example of a system for synchronizing storage groups in a data replication environment.

### DETAILED DESCRIPTION

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

As will be appreciated by one skilled in the art, the present invention may be embodied as an apparatus, system, method, or computer-program product. Furthermore, the present invention may take the form of a hardware embodiment, a software embodiment (including firmware, resident software, micro-code, etc.) configured to operate hardware, or an embodiment combining both software and hardware aspects that may all generally be referred to herein as a “module” or “system.” Furthermore, the present invention may take the form of a computer-usable medium embodied in any tangible medium of expression having computer-usable program code stored therein.

Any combination of one or more computer-usable or computer-readable medium(s) may be utilized to store the computer program product. The computer-usable or computer-readable medium may be, for example, an electronic, magnetic, optical, electromagnetic, infrared, or semiconductor system, apparatus, or device. More specific examples (a non-exhaustive list) of the computer-readable medium may include the following: an electrical connection having one or more wires, a portable computer diskette, a hard disk, a random access memory (“RAM”), a read-only memory (“ROM”), an erasable programmable read-only memory (“EPROM” or “Flash memory”), an optical fiber, a portable compact disc read-only memory (“CD-ROM”), an optical storage device, or a magnetic storage device. In the context of this document, a computer-usable or computer-readable medium may be any medium that can contain, store, or transport the program for use by or in connection with the instruction execution system, apparatus, or device.

Computer program code for carrying out operations of the present invention may be written in any combination of one or more programming languages, including an object-oriented programming language such as Java, Smalltalk, C++, or the like, and conventional procedural programming languages, such as the “C” programming language or similar programming languages. Computer program code for implementing the invention may also be written in a low-level programming language such as assembly language.

The present invention may be described below with reference to flowchart illustrations and/or block diagrams of methods, apparatus, systems, and computer program products according to various embodiments of the invention. It will be understood that each block of the flowchart illustrations and/or block diagrams, and combinations of blocks in the flowchart illustrations and/or block diagrams, can be implemented by computer program instructions or code. These computer program instructions may be provided to a processor of a general-purpose computer, special-purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide processes for implementing the functions/acts specified in the flowchart and/or block diagram block or blocks.

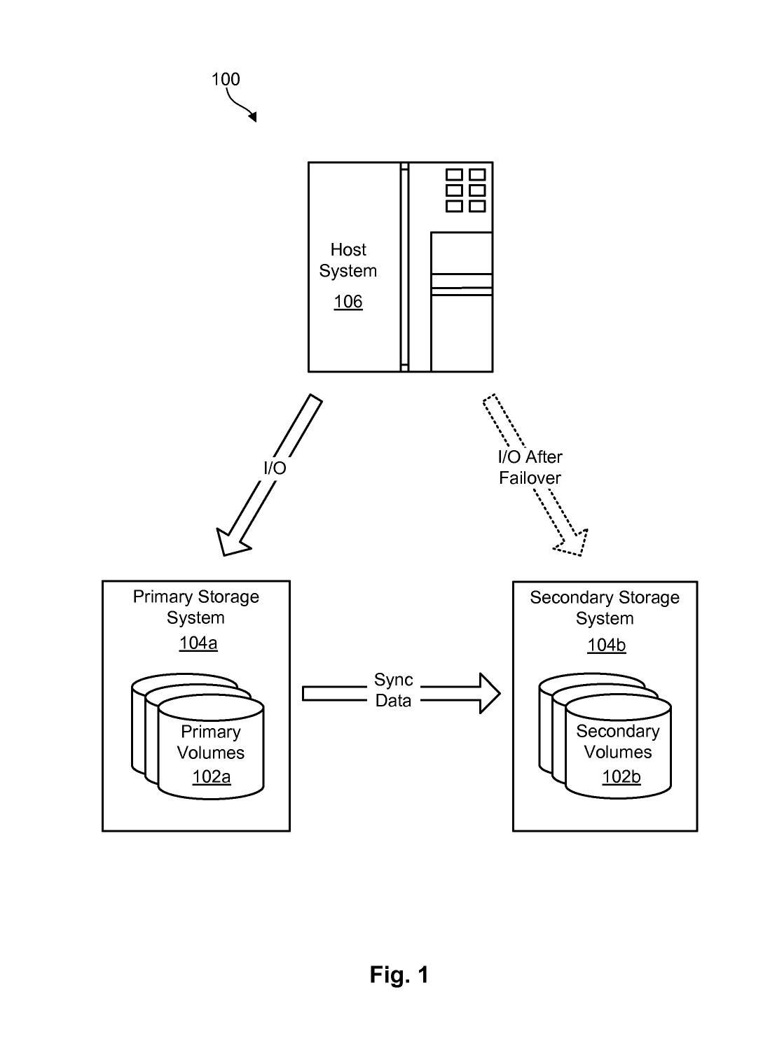

Referring to FIG. 1, one example of a data replication system 100, such as a Peer-to-Peer Remote Copy (“PPRC”) or Extended Remote Copy (“XRC”) system 100, is illustrated. The data replication system 100 is presented to show one example of an architecture in which embodiments of the invention might operate and is not intended to be limiting. In general, the data replication system 100 establishes a mirroring relationship between one or more primary volumes 102a and one or more secondary volumes 102b. Once this relationship is established, two consistent copies of data are maintained on the volumes 102a, 102b. The primary and secondary volumes 102a, 102b may be located on the same storage system 104, although the volumes 102a, 102b are typically located on separate storage systems 104a, 104b located some distance (e.g., several miles to thousands of miles) from one another. Channel extension equipment may be located between the storage systems 104a, 104b, as needed, to extend the distance over which the storage systems 104a, 104b may communicate.

The data replication system 100 may, in certain embodiments, be configured to operate in a synchronous manner, such as in PPRC implementations, or in an asynchronous manner, such as in XRC implementations. When operating synchronously, an I/O may only be considered complete when it has completed successfully on both the primary and secondary storage systems 104a, 104b. As an example, in such a configuration, a host system 106 may initially send a write request to the primary storage system 104a. This write operation may be performed on the primary storage system 104a. The primary storage system 104a may, in turn, transmit a write request to the secondary storage system 104b. The secondary storage system 104b may execute the write operation and return a write acknowledge message to the primary storage system 104a. Once the write has been performed on both the primary and secondary storage systems 104a, 104b, the primary storage system 104a returns a write acknowledge message to the host system 106. Thus, the write is only considered complete when the write has completed on both the primary and secondary storage systems 104a, 104b.

By contrast, asynchronous operation may only require that the write complete on the primary storage system 104a to be considered complete. That is, a write acknowledgement may be returned to the host system 106 when the write has completed on the primary storage system 104a, without requiring that the write be completed on the secondary storage system 104b. The write may then be mirrored to the secondary storage system 104b as time and resources allow to create a consistent copy on the secondary storage system 104b.

In the event the primary storage system 104a fails, I/O may be redirected to the secondary storage system 104b, thereby enabling continuous operations. This process may be referred to as a “failover.” Since the mirrored volumes 102b on the secondary storage system 104b contain a consistent copy of data on the corresponding volumes 102a on the primary storage system 104a, the redirected I/O (e.g., reads and writes) may be performed on the copy of the data on the secondary storage system 104b. When the primary storage system 104a is repaired or resumes operation, the I/O may once again be directed to the primary storage system 104a. This process may be referred to as a “failback.”

Although PPRC and XRC data replication systems 100 have been specifically mentioned herein, the systems and methods disclosed herein may be applicable to a wide variety of analogous data replication systems, including data replication systems produced or implemented by other vendors. Any data replication technology that could benefit from one or more embodiments of the invention is, therefore, deemed to fall within the scope of the invention.

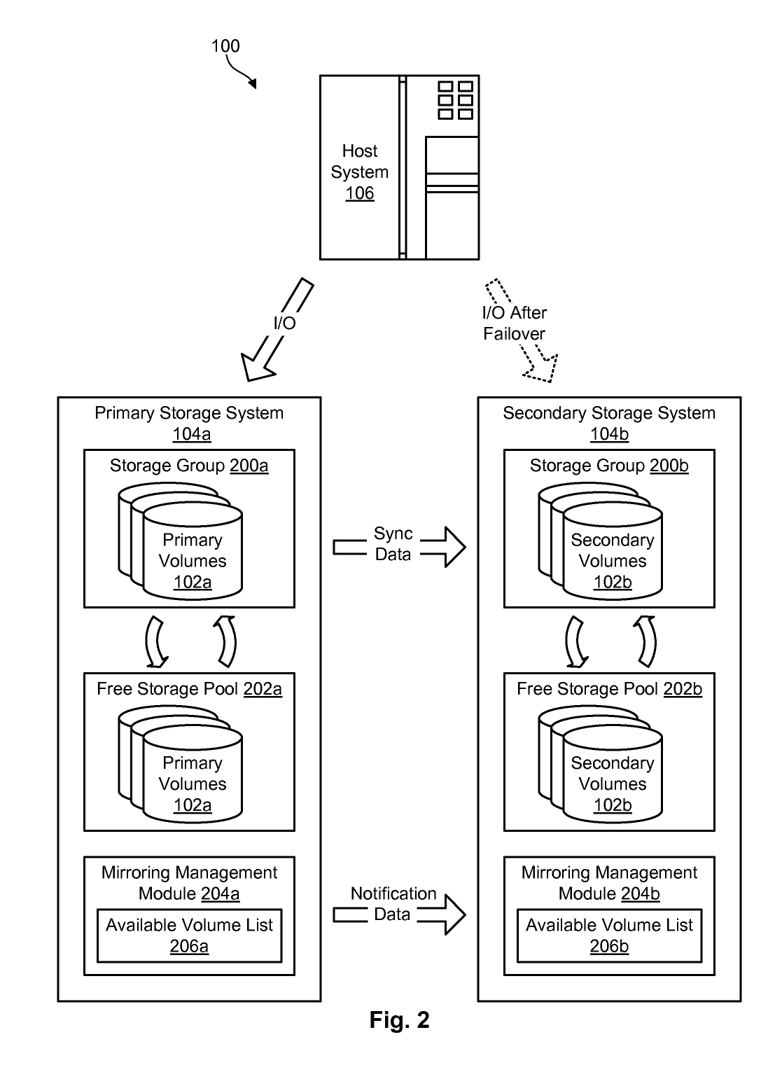

Referring to FIG. 2, as previously mentioned, in certain cases, users may establish storage groups 200 (i.e., pools of volumes 102a) on primary storage systems 104a for use by applications (resident on a host system 106) that use a certain type of data. When a storage group 200a is established on the primary storage system 104a, a corresponding storage group 200b may be established on the secondary storage system 104b for mirroring purposes. A mirroring relationship may be established between each primary volume 102a in the primary storage group 200a and each corresponding secondary volume 102b in the secondary storage group 200b. Each mirroring relationship associated with the storage groups 200a, 200b may be tied to a common “session” so that all volumes 102a in the storage group 200a can be recovered from a consistent point in time.

When users set up mirrored relationships between volumes 102a, 102b in the storage groups 200a, 200b, the user needs to ensure that any time changes are made to the storage group 200a on the primary storage system 104a, the same or similar changes are made to the storage group 200b on the secondary storage system 104b. This can be extremely difficult and time-consuming in environments where volumes are dynamically and automatically added to or removed from storage groups 200a (such as for end-of-month processing or other events that change space requirements) on the primary storage system 104a.

To address this problem, mirroring management modules 204a, 204b may be established in the primary and secondary storage systems 104a, 104b, or be configured to interface with the primary and secondary storage systems 104a, 104b. These mirroring management modules 204a, 204b may dynamically synchronize the storage groups 200a, 200b on the primary and secondary storage systems 104a, 104b. In the illustrated embodiment, each mirroring management module 204a, 204b maintains an available volume list 206a, 206b to coordinate and synchronize the storage groups 200a, 200b and “sessions” on the primary and secondary storage systems 104a, 104b on a dynamic basis. An available volume list 206a associated with the primary storage system 104a lists volumes 102a that are available in a free storage pool 202a of the primary storage system 104a (i.e., volumes 102a on the primary storage system 104a not currently in a “session”). An available volume list 206b associated with the secondary storage system 104b lists volumes 102b that are available in a free storage pool 202b of the secondary storage system 104b (i.e., volumes 102b on the secondary storage system 104b not currently in a “session”). The available volume lists 206a, 206b may be embodied as tables or other suitable data structures.

When a volume 102a is added to a primary storage group 200a from the free storage pool 202a, the mirroring management module 204a on the primary storage system 104a may remove the volume 102a from the available volume list 206a. The mirroring management module 204a may then send a notification to the secondary storage system 104b indicating that a volume 102a has been added to the storage group 200a. Upon receiving the notification, the mirroring management module 204b on the secondary storage system 104b may add a corresponding volume 102b to the storage group 200b and remove the volume 102b from the available volume list 206b. Once corresponding volumes 102a, 102b are added to the storage groups 200a, 200b, a mirroring relationship may be created between the volumes 102a, 102b. This will cause data to be copied from the primary volume 102a to the secondary volume 102b, as well as cause future writes to be mirrored.

The mirroring relationship may then be added to the “session” of the storage groups 200a, 200b, thereby allowing the newly added volume 102a to have a point of recovery that is consistent with other volumes 102a in the storage group 200a. For the purposes of this disclosure “adding” a mirroring relationship to a session may include assigning the mirroring relationship to a session number associated with one or more mirrored pairs of volumes 102a, 102b in the storage groups 200a, 200b. If any of the volumes 102a in the storage group 200a suspend mirroring, then all of the other volumes 102a in the storage group 200a will suspend mirroring at the same point in time.

The mirroring management modules 204a, 204b in the primary storage system 104a and secondary storage system 104b may be identical or substantially identical since the roles of the primary and secondary storage systems 104a, 104b may be reversed, such as when a failover occurs. That is, in certain situations, the primary storage system 104a may become the secondary storage system 104b, and the secondary storage system 104b may become the primary storage system 104a. Thus, each storage system 104 may be configured with the same or substantially the same functionality, although not all the functionality may be active or utilized at any given time. Some functionality may be active if the storage system 104 is acting as the primary storage system 104a, while other functionality may be active if the storage system 104 is acting as the secondary storage system 104b.

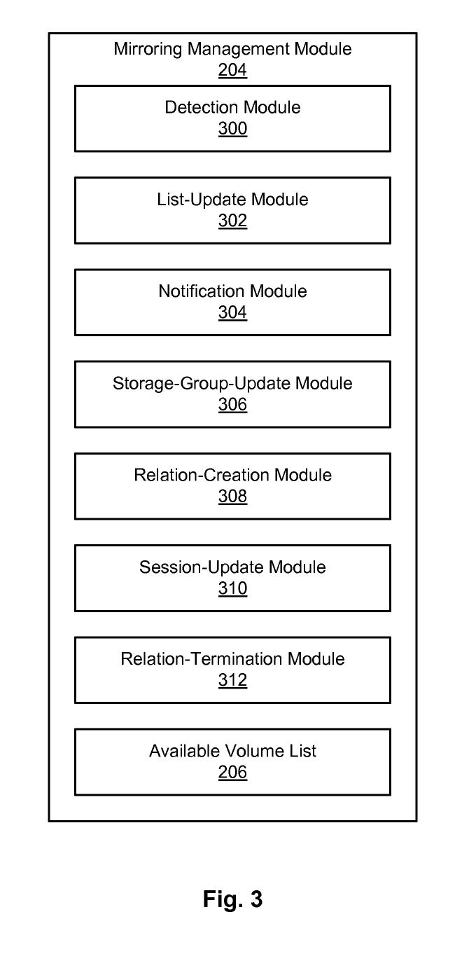

Referring to FIG. 3, the mirroring management modules 204a, 204b illustrated in FIG. 2 may include one or more internal modules to provide various features and various functions. These modules may be implemented in hardware, software or firmware executable on hardware, or a combination thereof. The modules are presented only by way of example and are not intended to be limiting. Indeed, alternative embodiments may include more or fewer modules than those illustrated. It should also be recognized that, in some embodiments, the functionality of some modules may be broken into multiple modules, or conversely, the functionality of several modules may be combined into a single module or fewer modules.

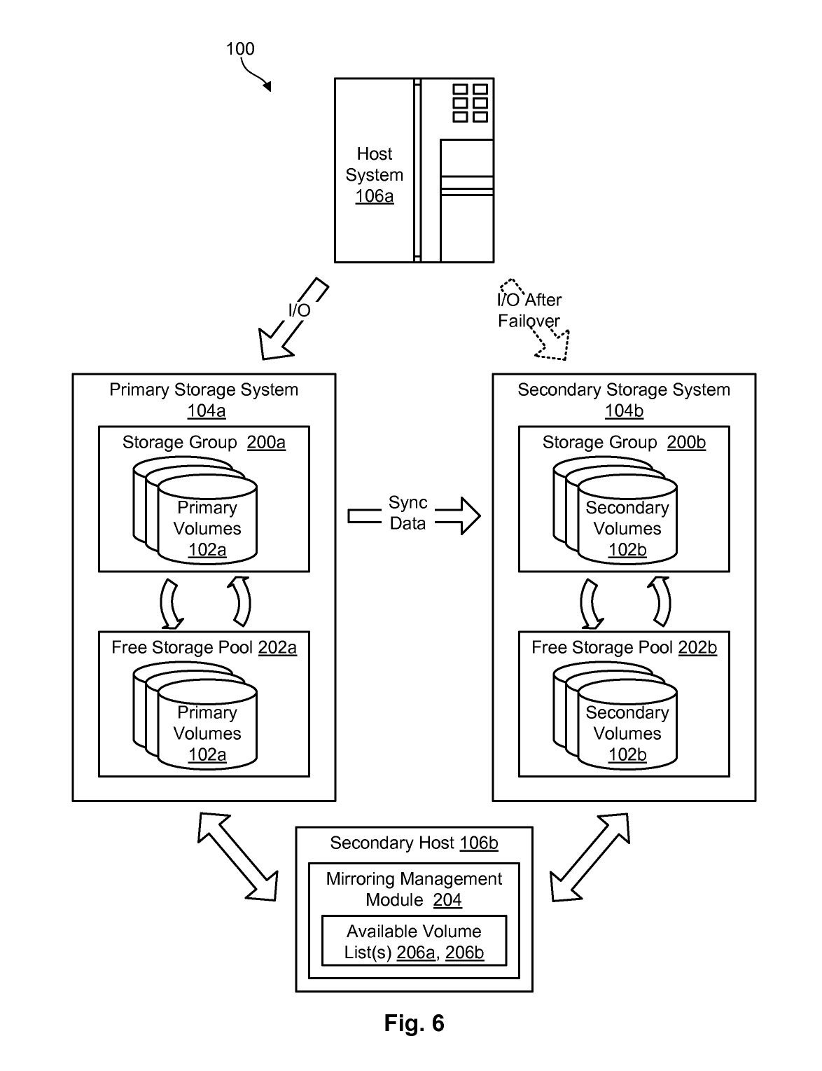

It should also be recognized that the modules are not necessarily implemented in the locations where they are illustrated. For example, some or all of the functionality shown in the primary storage system 104a or secondary storage system 104b may actually be implemented in a separate control system. For example, in the XRC data replication system 100, a system data mover (SDM) residing on a host system 106 may be used to copy writes from a primary storage system 104a to a secondary storage system 104b. In such embodiments, some or all of the functionality of the mirroring management modules 204a, 204b, including the available volume lists 206a, 206b, may be implemented in the host system 106 acting as the SDM. One example of such a configuration will be discussed in association with FIG. 6. Thus, the location of the modules illustrated in FIGS. 2 and 3 is presented only by way of example and is not intended to be limiting.

As shown, a mirroring management module 204 may include one or more of a detection module 300, a list-update module 302, a notification module 304, a storage-group-update module 306, a relation-creation module 308, a session-update module 310, and a relation-termination module 312. The detection module 300 may be configured to detect when a volume 102a on the primary storage system 104a has been added to a storage group 200a from the free storage pool 202a. Upon detecting such, a list-update module 302 may remove the volume 102a from the available volume list 206a associated with the primary storage system 104a. A notification module 304 may then send a notification to the secondary storage system 104b or other hardware component (e.g., system data mover in XRC implementations) indicating that a volume 102a has been added to the storage group 200a.

When the notification is received by the secondary storage system 104b or other hardware component, a storage-group-update module 306 may add a corresponding volume 102b to the storage group 200b on the secondary storage system 104b. A list-update module 302 may then remove the volume 102b from the available volume list 206b associated with the secondary storage system 104b. Once corresponding volumes 102a, 102b are added to the storage groups 200a, 200b, a relation-creation module 308 creates a mirroring relationship between the newly added volumes 102a, 102b. A session-update module 310 then adds the mirroring relationship to the “session” of the storage groups 200a, 200b. This will ensure that the newly added volume 102a has a point of recovery that is consistent with other volumes 102a in the storage group 200a.

A similar process may be performed when a primary volume 102a is removed from a storage group 200a. In particular, when the detection module 300 detects that a volume 102a has been removed from a storage group 200a, the list-update module 302 may add the volume 102a to the available volume list 206a associated with the primary storage system 104a (indicating that the volume 102a has been returned to the free storage pool 202a). The notification module 304 may then send a notification to the secondary storage system 104b or other hardware component indicating that a volume 102a has been removed from the storage group 200a.

Upon receiving the notification, the storage-group-update module 306 may remove the corresponding volume 102b from the storage group 200b on the secondary storage system 104b and the list-update module 302 may add the volume 102b to the available volume list 206b. Once corresponding volumes 102a, 102b have been removed from the storage groups 200a, 200b, a relation-termination module 312 may terminate the mirroring relationship between the removed volumes 102a, 102b. This will remove the mirroring relationship from the “session” associated with the storage groups 200a, 200b.

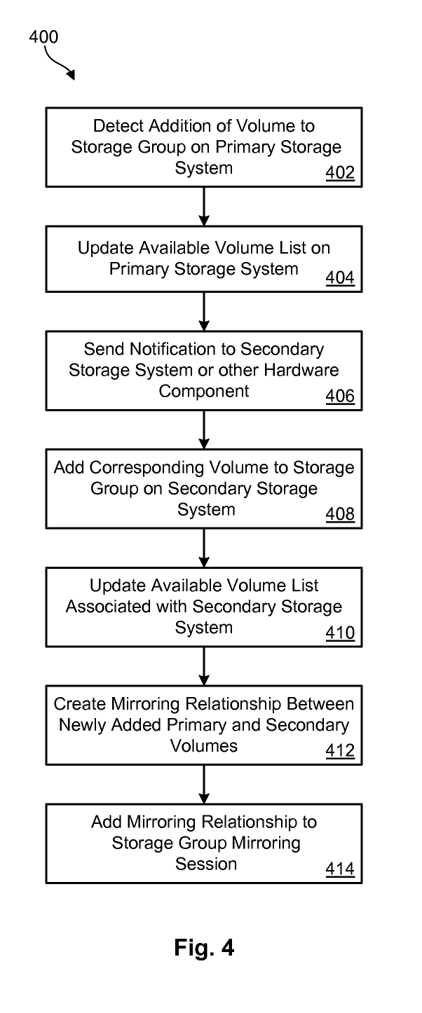

Referring to FIG. 4, one embodiment of a method 400 for synchronizing storage groups 200a, 200b when a volume 102a is added to a storage group 200a on a primary storage system 104a is illustrated. Such a method 400 may be executed by the primary and secondary storage systems 104a, 104b and/or other hardware components (e.g., a host system 106 used as a system data mover) interfacing with the primary and secondary storage systems 104a, 104b. As shown, the method 400 initially detects 402 when a volume 102a on the primary storage system 104a is added to a storage group 200a from the free storage pool 202a. The method 400 then updates 404 the available volume list 206a associated with the primary storage system 104a by removing the volume 102a from the list 206a. A notification is then sent 406 to the secondary storage system 104b or other hardware component indicating that a volume 102a has been added to the storage group 200a.

Upon receiving the notification, the method 400 adds 408a corresponding volume 102b to the storage group 200b on the secondary storage system 104b. In doing so, the method 400 may look at the physical characteristics of the volume 102a added to the storage group 200a (e.g., which logical subsystem (LSS) the volume 102a belongs to) and add 408 a volume 102b with corresponding physical characteristics to the secondary storage group 200b (e.g., a volume 102b from the corresponding LSS). The method 400 then updates 410 the available volume list 206b associated with the secondary storage system 104b by removing the volume 102b from the list 206b. Once corresponding volumes 102a, 102b have been added to the storage groups 200a, 200b, the method 400 creates 412 a mirroring relationship (using an XADDPAIR command, for example) between the newly added volumes 102a, 102b. This will synchronize the volumes 102a, 102b by copying data from the primary volume 102a to the secondary volume 102b. The method 400 then adds 414 the mirroring relationship to the “session” associated with the storage groups 200a, 200b.

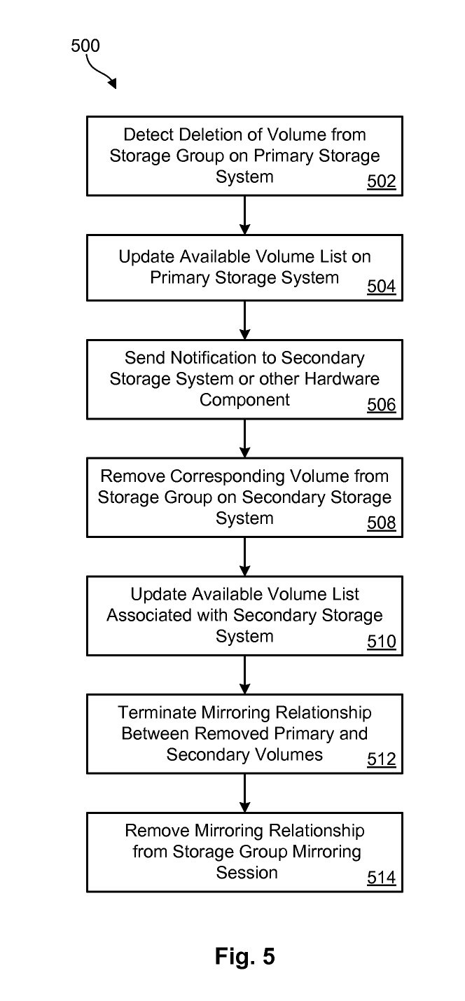

Referring to FIG. 5, one embodiment of a method 500 for synchronizing storage groups 200a, 200b when a volume 102a is removed from a storage group 200a on a primary storage system 104a is illustrated. Such a method 500 may be executed by the primary and secondary storage systems 104a, 104b and/or other hardware components interfacing with the primary and secondary storage systems 104a, 104b. As shown, the method 500 initially detects 502 when a volume 102a on the primary storage system 104a has been removed from a storage group 200a and returned to the free storage pool 202a. The method 500 then updates 504 the available volume list 206a associated with the primary storage system 104a by adding the removed volume 102a to the list 206a. A notification is then sent 506 to the secondary storage system 104b or other hardware component interfacing with the secondary storage system 104b indicating that a volume 102a has been removed from the storage group 200a.

Upon receiving the notification, the method 500 removes 508 the corresponding volume 102b from the storage group 200b on the secondary storage system 104b. The method 500 then updates 510 the available volume list 206b associated with the secondary storage system 104b by adding the volume 102b to the list 206b. This will allow the removed volume 102b to be used in future mirroring relationships in the same or other storage groups 200. Once the corresponding volumes 102a, 102b are removed from the storage groups 200a, 200b, the method 500 terminates 512 the mirroring relationship (using an XDELPAIR command, for example) between the removed volumes 102a, 102b. This will remove 514 the mirroring relationship from the “session” associated with the storage groups 200a, 200b.

Referring to FIG. 6, as previously mentioned, all or part of the functionality of the mirroring management modules 204a, 204b may be implemented in a separate control system, such as a secondary host system 106b used as a system data mover (SDM). When primary volumes 102a are added or removed from a storage group 200a on the primary storage system 104a, the secondary host system 106b may add or remove corresponding volumes 102b to or from the storage group 200b on the secondary storage system 104b. The secondary host system 106b may also, in certain embodiments, maintain the available volume lists 206a, 206b associated with the primary and secondary storage systems 104a, 104b as volumes 102a, 102b are added to or removed from the free storage pools 202a, 202b.

When volumes 102a, 102b are added to the storage groups 200a, 200b, the secondary host system 106b may create a mirroring relationship between the volumes 102a, 102b. The secondary host system 106b may add this mirroring relationship to the “session” associated with the storage groups 200a, 200b. Similarly, when volumes 102a, 102b are removed from the storage groups 200a, 200b, the secondary host system 106b may terminate the mirroring relationship between the volumes 102a, 102b.

The hardware and software configurations illustrated in FIGS. 2 and 6 are simply examples of configurations that may be used to implement systems and methods in accordance with the invention. Other hardware and software configurations are possible and within the scope of the invention. The scope of the invention is, therefore, dictated by the appended claims, rather than the foregoing description.

The flowcharts and block diagrams in the Figures illustrate the architecture, functionality, and operation of possible implementations of systems, methods, and computer-usable media according to various embodiments of the present invention. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

1. A method for dynamically synchronizing storage groups in a data replication environment, the method comprising:
detecting the addition of a first volume to a first storage group of a primary storage system;
automatically performing the following in response to detecting the addition of the first volume:
adding a corresponding second volume to a second storage group of a secondary storage system;
creating a mirroring relationship between the first volume and the second volume, such that writes to the first volume are automatically mirrored to the second volume; and
adding the mirroring relationship to a mirroring session established between the first and second storage groups, the mirroring session providing a consistent point of recovery for volumes in the first storage group.

2. The method of claim 1, further comprising sending a notification in response to detecting the addition of the first volume.

3. The method of claim 2, wherein automatically performing comprises automatically performing in response to receiving the notification.

4. The method of claim 1, wherein the mirroring relationship is a synchronous mirroring relationship, thereby causing writes to the first volume to be synchronously mirrored to the second volume.

5. The method of claim 1, wherein the mirroring relationship is an asynchronous mirroring relationship, thereby causing writes to the first volume to be asynchronously mirrored to the second volume.

6. The method of claim 1, wherein detecting the addition of the first volume to the first storage group further comprises removing the first volume from an available volume list associated with the primary storage system.

7. The method of claim 1, wherein adding the corresponding second volume to the second storage group further comprises removing the second volume from an available volume list associated with the secondary storage system.

8. The method of claim 1, further comprising detecting the removal of the first volume from first storage group.

9. The method of claim 8, further comprising automatically removing the second volume from the second storage group in response to detecting the removal of the first volume.

10. The method of claim 9, further comprising automatically terminating the mirroring relationship between the first volume and the second volume in response to detecting the removal of the first volume.

11. A computer program product for dynamically synchronizing storage groups in a data replication environment, the computer program product comprising a non-transitory computer-readable storage medium having computer-usable program code stored thereon, the computer-usable program code comprising:
computer-usable program code to detect the addition of a first volume to a first storage group of a primary storage system;
computer-usable program code to automatically perform the following in response to detecting the addition of the first volume:
add a corresponding second volume to a second storage group of a secondary storage system;
create a mirroring relationship between the first volume and the second volume, such that writes to the first volume are automatically mirrored to the second volume; and
add the mirroring relationship to a mirroring session established between the first and second storage groups, the mirroring session providing a consistent point of recovery for volumes in the first storage group.

12. The computer program product of claim 11, further comprising computer-usable program code to send a notification in response to detecting the addition of the first volume.

13. The computer program product of claim 12, wherein automatically performing comprises automatically performing in response to receiving the notification.

14. The computer program product of claim 11, wherein detecting the addition of the first volume to the first storage group further comprises removing the first volume from an available volume list associated with the primary storage system.

15. The computer program product of claim 11, wherein adding the corresponding second volume to the second storage group further comprises removing the second volume from an available volume list associated with the secondary storage system.

16. The computer program product of claim 11, further comprising computer-usable program code to detect the removal of the first volume from the first storage group.

17. The computer program product of claim 16, further comprising computer-usable program code to automatically remove the second volume from the second storage group in response to detecting the removal of the first volume.

18. The computer program product of claim 17, further comprising computer-usable program code to automatically terminate the mirroring relationship between the first volume and the second volume in response to detecting the removal of the first volume.

19. The computer program product of claim 11, wherein the mirroring relationship is one of a synchronous mirroring relationship and an asynchronous mirroring relationship.

20. A system for dynamically synchronizing storage groups in a data replication environment, the system comprising:
at least one processor;
at least one memory device coupled to the at least processor and storing computer instructions for execution on the at least one processor, the computer instructions causing the at least one processor to collectively:
detect the addition of a first volume to a first storage group of a primary storage system;
add a corresponding second volume to a second storage group of a secondary storage system in response to detecting the addition of the first volume;
create a mirroring relationship between the first volume and the second volume, such that writes to the first volume are automatically mirrored to the second volume; and
add the mirroring relationship to a mirroring session established between the first and second storage groups, the mirroring session providing a consistent point of recovery for volumes in the first storage group.
